(19) United States
(12) Patent Application Publication
(10) Pub. No.: US 2025/0015570 A1
(43) Pub. Date: Jan. 9, 2025

(54) COATING REMOVAL APPARATUS

(71) Applicant: Yazaki Corporation, Tokyo (JP)

(72) Inventor: Naoya YAGUCHI, Shizuoka (JP)

(73) Assignee: Yazaki Corporation, Tokyo (JP)

(21) Appl. No.: 18/732,034

(22) Filed: Jun. 3, 2024

(30) Foreign Application Priority Data
Jul. 6, 2023 (JP) 2023-111455

(51) Int. Cl. H02G 1/12; H01R 43/28

(52) U.S. Cl. CPC H02G 1/126; H01R 43/28

(57) ABSTRACT

A coating removal apparatus includes a plurality of contact portions that are in surface contact with an outer circumferential surface of a coated electric wire having a circular cross section, the coated electric wire being formed with a notch in a circumferential direction on the outer circumferential surface, the contact portions being configured to sandwich the coated electric wire, and moving means configured to move the contact portions sandwiching the coated electric wire and the coated electric wire relative to each other in a longitudinal direction of the coated electric wire. The contact portions come into surface contact with an end side of the coated electric wire that is closer to an end of the coated electric wire than the notch, and are moved relatively to the end side in the longitudinal direction of the coated electric wire, so that a coating of the coated electric wire is stripped.

### TECHNICAL FIELD

The present disclosure relates to a coating removal apparatus for removing coating of a coated electric wire.

### BACKGROUND

A coating removal apparatus that removes the coating from the end of a coated electric wire in order to connect a terminal to the end is known (see, for example, Patent Document 1).

FIG. 8 is an explanatory diagram for explaining a coating removal method using a conventional coating removal apparatus. The coating removal apparatus illustrated in FIG. 8 removes a coating 11 and a metal foil 12 of the coated electric wire 10 illustrated in FIG. 7, for example. The coated electric wire 10 is an electric wire having a circular cross section and has a structure in which a conductive core wire 15 is surrounded by an insulator 14, a braid 13, a metal foil 12, and an insulating coating 11.

The coating removal apparatus illustrated in FIG. 8 includes a pair of cutters 16 each having a V-shaped blade portion 16a, and moving means for moving these cutters 16. The pair of cutters 16 move toward each other and pierce the coating 11 and the metal foil 12 of the coated electric wire 10, and rotate in the direction of the arrow to make circumferential cuts in the coating 11 and the metal foil 12. Next, the pair of cutters 16 moves toward the end in the longitudinal direction of the coated electric wire 10 to remove the portion of the coating 11 and the metal foil 12 that are closer to the end than the notch.

It should be noted that black portions 18 in FIG. 8 indicate contact portions where the cutters 16 come into contact with the coating 11 and the metal foil 12 when the cutters 16 move to the longitudinal end of the coated electric wire 10 and removes the coating 11 and the metal foil 12.

### RELATED ART

### Patent Document

Patent Document 1: JP2015035278 (A)

### SUMMARY OF THE INVENTION

### Problem to be Solved by the Invention

In the conventional art described above, the only portions where the cutters 16 come into contact with the coated electric wire 10 when stripping the coating 11 and the metal foil 12 are the contact portions 18 illustrated in FIG. 8. For this reason, if the coating 11 is made of a soft material such as silicone, only a portion of the coating 11 deforms (turns over or the like) during stripping, as illustrated in FIG. 9, and the stripping force is not transmitted thereto, causing a problem that stripping cannot be performed properly. Furthermore, when the removal portion of the coating 11 is long, the areas of the contact portions 18 are similarly small, which causes the coating 11 to deform, making it difficult to perform stripping properly. Note that reference symbol 17 in FIG. 9 indicates a notch.

Accordingly, it is an object of the present disclosure to provide a coating removal apparatus that can effectively remove coating even when the coating is made of a soft material or when the removal portion of the coating is long.

### Solution to Problem

An aspect of the present disclosure is a coating removal apparatus including a plurality of contact portions that are configured to be in surface contact with an outer circumferential surface of a coated electric wire having a circular cross section, the coated electric wire being formed with a notch in a circumferential direction on the outer circumferential surface, the contact portions being configured to sandwich the coated electric wire, and moving means configured to move the plurality of contact portions sandwiching the coated electric wire and the coated electric wire relative to each other in a longitudinal direction of the coated electric wire, wherein the plurality of contact portions come into surface contact with an end side of the coated electric wire that is closer to an end of the coated electric wire than the notch, and are moved relatively to the end side in the longitudinal direction of the coated electric wire, so that a coating of the coated electric wire is stripped.

### Advantageous Effects of the Invention

According to an aspect of the present disclosure, the plurality of contact portions come into surface contact with an end side of the coated electric wire that is closer to an end of the coated electric wire than the notch, and are moved relatively to the end side in the longitudinal direction of the coated electric wire, so that a coating of the coated electric wire is stripped. Therefore, coating can be effectively removed even when the coating is made of a soft material or when the removal portion of the coating is long.

### BRIEF DESCRIPTION OF THE DRAWINGS

FIG. 1 is a schematic configuration diagram of a coating removal apparatus according to a first embodiment of the present invention.

FIG. 2 is a diagram of the coating removal apparatus illustrated in FIG. 1 as seen from a different direction.

FIG. 3 is a schematic configuration diagram of a coating removal apparatus according to a second embodiment of the present invention.

FIG. 4 is a diagram illustrating a state in which a pair of contact portions in FIG. 3 sandwich a coated electric wire.

FIG. 5 is a diagram of the coating removal apparatus illustrated in FIG. 4 as seen from a different direction.

FIG. 6 is a schematic configuration diagram of a coating removal apparatus according to a third embodiment of the present invention.

FIG. 7 is an explanatory diagram for explaining a cross-sectional structure of a coated electric wire.

FIG. 8 is an explanatory diagram for explaining a coating removal method using a conventional coating removal apparatus.

FIG. 9 is an explanatory diagram for explaining a problem with the coating removal method using the conventional coating removal apparatus.

### DETAILED DESCRIPTION OF THE EXEMPLARY EMBODIMENT

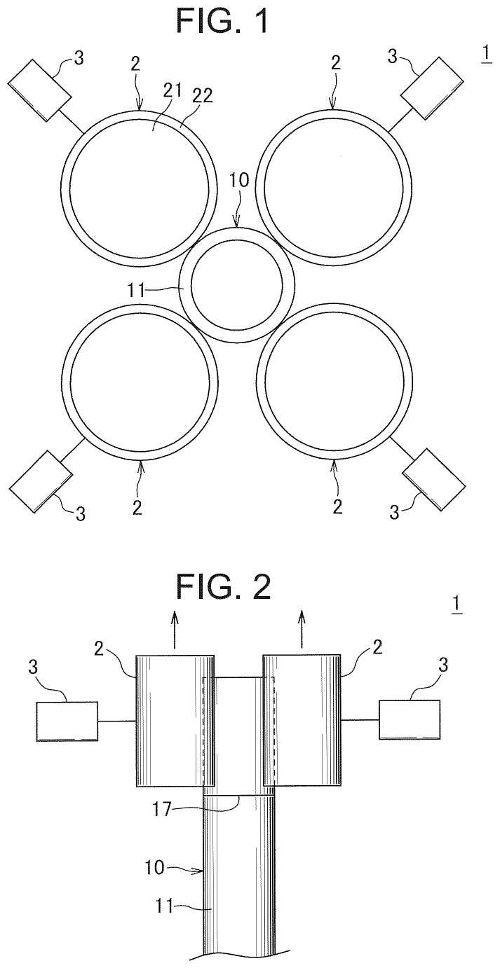

The “coating removal apparatus” according to the first embodiment of the present invention is explained with reference to FIGS. 1, 2.

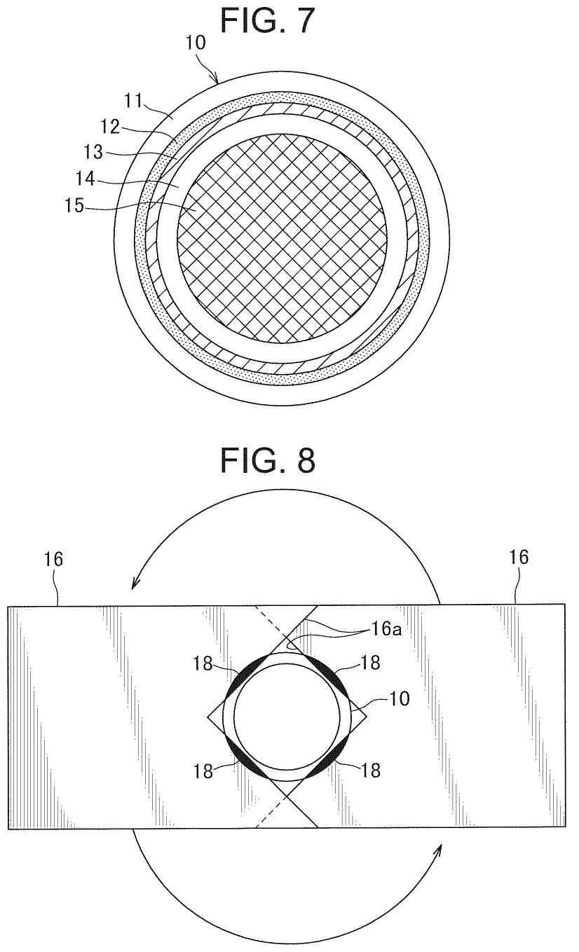

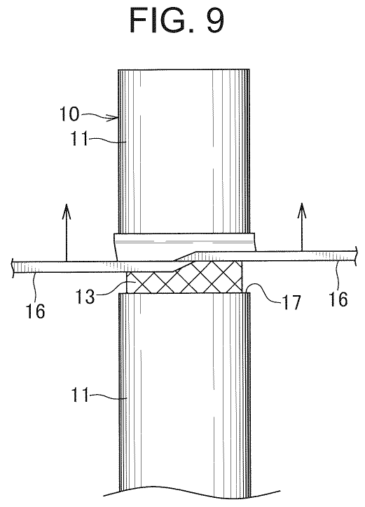

The coating removal apparatus 1 illustrated in FIGS. 1 and 2 removes the coating 11 of the coated electric wire 10 illustrated in FIG. 7, for example. The coated electric wire 10 is an electric wire having a circular cross section and has a structure in which a conductive core wire 15 is surrounded by an insulator 14, a braid 13, a metal foil 12, and an insulating coating 11 in this order. The material of the coating 11 may be polyvinyl chloride, polyethylene, silicone, or the like, but the coating removal apparatus 1 is designed to be able to effectively remove the coating 11 even when the coating 11 is made of a soft material such as silicone or when the removal portion of the coating 11 is long.

The coating removal apparatus 1 is for stripping off the coating 11 that is closer to the end than a notch 17 of the coated electric wire 10, which is formed with the notch 17 in the circumferential direction on its outer circumferential surface. The notch 17 extends all the way around the coated electric wire 10. The processing method for making the notches 17 may be a method using the pair of conventional cutters 16 described above, or another method may be used.

The coating removal apparatus 1 includes a holding unit (not illustrated) configured to hold the coated electric wire 10, four contact portions 2 that are in surface contact with the outer circumferential surface of the coated electric wire 10 and sandwich the coated electric wire 10 therebetween, moving means 3 configured to move the respective contact portions 2, and a control unit (not illustrated).

The holding unit holds the portion of the coated electric wire 10 that is closer to the center than the notch 17 (i.e., the portion where the coating 11 is not to be stripped). A well-known chuck or the like can be used as this holding unit.

All four contact portions 2 have the same configuration. Each contact portion 2 includes a cylindrical body portion 21 and a rubber portion 22 provided around the entire outer circumferential surface of the body portion 21. That is, each contact portion 2 has a contact surface for contact with the coated electric wire 10 made of rubber. These contact portions 2 are moved to the end side in the longitudinal direction of the coated electric wire 10 while being in surface contact with an end side of the coated electric wire 10 that is closer to the end than the notch 17 of the coated electric wire 10, thereby stripping the coating 11 of the coated electric wire 10.

By increasing the contact area with the coating 11, the contact portion 2 can prevent deformation of the coating 11 and can strip the coating 11. In addition, since the contact portion 2 has a rubber contact surface for contact with the coated electric wire 10, the frictional force of the contact surface can be increased to prevent slipping, so that the coating 11 can be more reliably stripped. Further, although, in this example, the contact portion 2 is constituted by the body portion 21 and the rubber portion 22, the entire contact portion 2 may be made of rubber.

The moving means 3 moves the contact portion 2 in the radial direction of the coated electric wire 10 and in the longitudinal direction of the coated electric wire 10. The moving means 3 includes a first air cylinder that moves the contact portion 2 in the radial direction of the coated electric wire 10, and a second air cylinder that moves, along with the first air cylinder, the contact portion 2 in the longitudinal direction of the coated electric wire 10. Other than this, the moving means may be configured with a robot arm, an electric actuator, or the like.

The above control unit controls the holding unit and moving means 3. The control unit stores multiple drive programs in which the product number of the coated electric wire 10 and the amount of movement of the moving means 3 (the amount of air to be supplied to the first air cylinder and the second air cylinder) are associated. Therefore, by specifying a drive program to the control unit, the coating removal apparatus 1 can perform coating removal on multiple types of coated electric wires with different product numbers. For example, in order to perform coating removal of a coated electric wire with a smaller diameter than that illustrated in FIG. 1, the distance that each contact portion 2 moves in the wire radial direction (the distance that the contact portion 2 moves until the contact portion 2 comes into surface contact with the coated electric wire) becomes longer. The reason why multiple types of coated electric wires with different diameters can be sandwiched is that the coating removal apparatus 1 is equipped with four cylindrical contact portions 2. In addition, if the coating removal length is longer than that illustrated in FIG. 2, the distance that each contact portion 2 moves in the longitudinal direction of the wire will be longer.

Next, an example of a coating removal method using the above coating removal apparatus 1 is explained. The coating 11 of the coated electric wire 10 in this example is made of soft silicone. In this example, the coating 11 and the metal foil 12 are removed at the same time. Therefore, the notch 17 placed in the coated electric wire 10 in advance reaches from the surface of the coating 11 to the layer of the metal foil 12.

When a work start signal is input to the control unit, the holding unit that holds the coated electric wire 10 containing the notch 17 moves, and the coated electric wire 10 is set between the four contact portions 2 that are spaced apart from each other. Next, the first air cylinder of the moving means 3 is driven, so that the four contact portions 2 approach each other, and these contact portions 2 come into surface contact with an end side of the coated electric wire 10 that is closer to the end than the notch 17. That is, the coated electric wire 10 is sandwiched between the four contact portions 2 (the state illustrated in FIGS. 1 and 2). Then, as the second air cylinder of the moving means 3 is driven, the four contact portions 2 sandwiching the coated electric wire 10 move to the end side in the longitudinal direction of the coated electric wire 10, and as a result, the end sides of the coating 11 and the metal foil 12 that are closer to the end than the notch 17 are stripped.

As described above, in the coating removal apparatus 1, multiple contact portions 2 having lengths in the longitudinal direction of the coated electric wire 10 move to the end side in the longitudinal direction of the electric wire to strip the coating 11 while the contact portions 2 having are in surface contact with the outer circumferential surface of the coated electric wire 10. Therefore, as compared to the conventional technique (for example, the contact portion 18 illustrated in FIG. 8), the contact area of the contact portion 2 with coated electric wire 10 is larger, and a larger frictional force is generated between contact portion 2 and coating 11, so that deformation of coating 11 can be prevented. Furthermore, since the contact area is increased, pressure is dispersed and no large force is applied to a portion of the coating 11, making the coating 11 less likely to deform. Therefore, even if the material of the coating 11 is a soft material, the coating 11 can be removed effectively. Furthermore, even if the removal portion of the coating 11 is long, the same effect as described above can be obtained and the coating can be removed successfully.

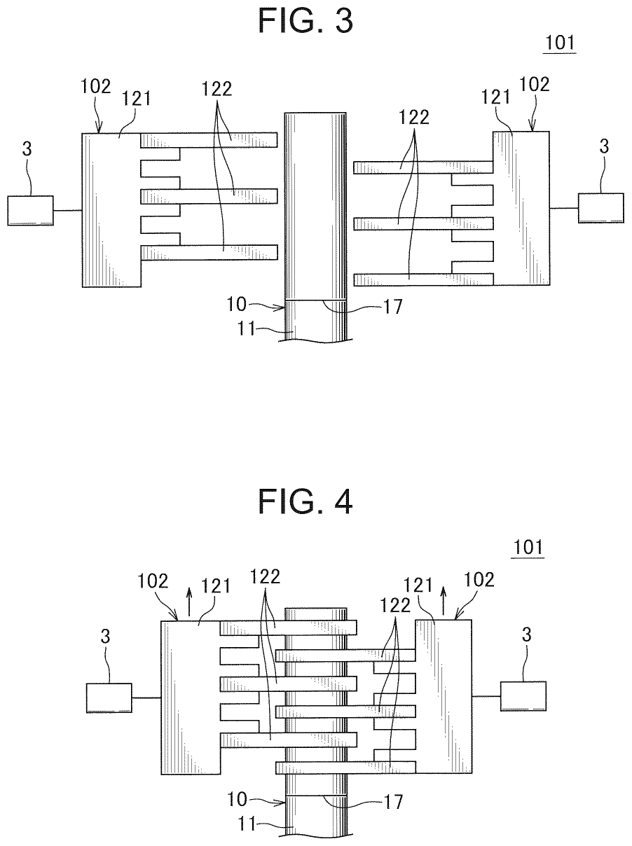

The “coating removal apparatus” according to a second embodiment of the present invention is explained with reference to FIGS. 3 to 5. In FIGS. 3 to 5, the same components as those in the first embodiment described above are denoted with the same reference numerals and explanations are omitted.

The coating removal apparatus 101 illustrated in FIGS. 3 to 5 is used to remove the coating 11 of the coated electric wire 10 illustrated in FIG. 7, for example, as in the first embodiment. The coating removal apparatus 101 includes a holding unit (not illustrated) configured to hold the coated electric wire 10, a pair of contact portions 102 that are in surface contact with the outer circumferential surface of the coated electric wire 10 and sandwich the coated electric wire 10 therebetween, moving means 3 configured to move the respective contact portions 102, and a control unit (not illustrated). The holding unit and the moving means 3 have the same configuration as the first embodiment.

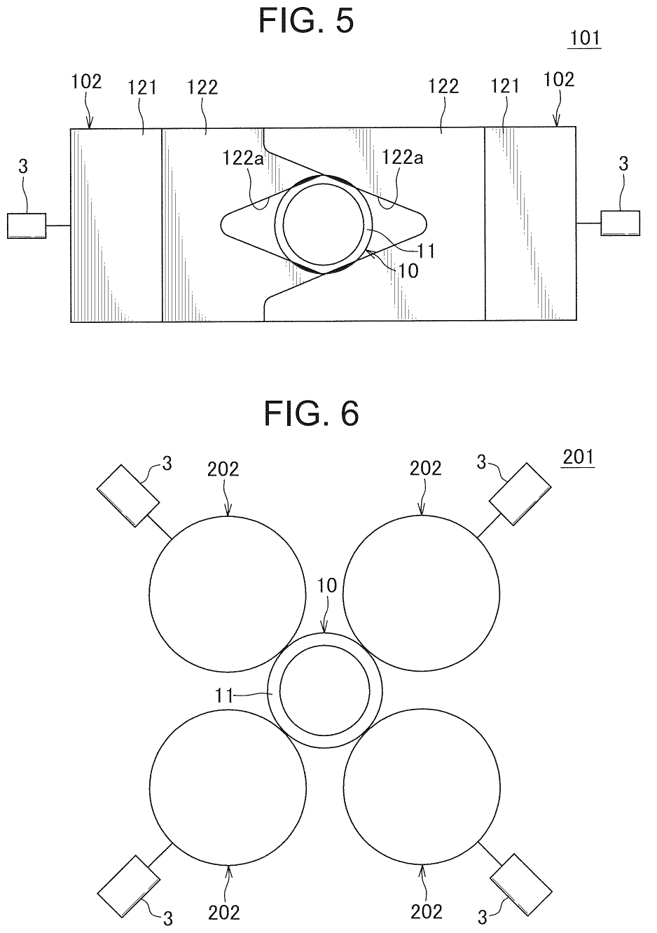

Each contact portion 102 includes multiple metal plates 122 arranged at intervals in the longitudinal direction of the coated electric wire 10, and a base 121 to which the plurality of plates 122 are fixed. The multiple plates 122 protrude from the base 121 toward the coated electric wire 10. As illustrated in FIG. 5, each plate 122 is formed with a V-shaped groove 122a in which the coated electric wire 10 is positioned.

As illustrated in FIGS. 4 and 5, the pair of contact portions 102 move toward each other to position the coated electric wire 10 within the groove 122a of each plate 122, and comes into surface contact with the end side of the coated electric wire 10 that is closer to the end than the notch 17. That is, the inner surface of the groove 122a is in surface contact with the outer circumferential surface of the coated electric wire 10. In this manner, with the coated electric wire 10 being sandwiched between the pair of contact portions 102, the plate 122 of one contact portion 102 and the plate 122 of the other contact portion 102 are arranged alternately in the longitudinal direction of the electric wire. In addition, a space is provided between the alternately arranged plates 122 in the longitudinal direction of the electric wire. These pair of contact portions 102 are moved to the end side in the longitudinal direction of the coated electric wire 10 while being in surface contact with the end side of the coated electric wire 10 that is closer to the end than the notch 17, so that the coating 11 of the coated electric wire 10 is stripped.

The contact portions 102 have multiple plates 122 forming protrusions, and the coated electric wire 10 is sandwiched between the protrusions. The contact portions 102 can strip the coating 11 to prevent deformation of the coating 11 by using multiple plates 122. Furthermore, since each plate 122 is thin, the tip thereof bites into the coating 11 to prevent slipping. Therefore, the coating 11 can be removed more reliably.

Next, an example of a coating removal method using the above coating removal apparatus 101 is explained. The coating 11 of the coated electric wire 10 in this example is made of soft silicone. In this example, the coating 11 and the metal foil 12 are removed at the same time. Therefore, the notch 17 placed in the coated electric wire 10 in advance reaches from the surface of the coating 11 to the layer of the metal foil 12.

When a work start signal is input to the control unit, the holding unit that holds the coated electric wire 10 containing the notch 17 moves, and the coated electric wire 10 is set between the pair of contact portions 102 that are spaced apart from each other (the state as illustrated in FIG. 3). Next, the first air cylinder of the moving means 3 is driven, so that the pair of contact portions 102 approach each other, and these contact portions 102 come into surface contact with an end side of the coated electric wire 10 that is closer to the end than the notch 17. That is, the coated electric wire 10 is sandwiched between the pair of contact portions 102 (the state illustrated in FIGS. 4 and 5). Then, as the second air cylinder of the moving means 3 is driven, the pair of contact portions 102 sandwiching the coated electric wire 10 move to the end side in the longitudinal direction of the coated electric wire 10, and as a result, the end portions of the coating 11 and the metal foil 12 that are closer to the end than the notch 17 are stripped.

Like the coating removal apparatus 1 of the first embodiment, the coating removal apparatus 101 described above can effectively remove the coating 11 even if the material of the coating 11 is a soft material, or even if the removal portion of the coating 11 is long.

The “coating removal apparatus” according to a third embodiment of the present invention is explained with reference to FIG. 6. In FIG. 6, the same components as those in the first embodiment described above are denoted with the same reference numerals and explanations are omitted.

A coating removal apparatus 201 illustrated in FIG. 6 has four contact portions 202 instead of the four contact portions 2 of the coating removal apparatus 1 of the first embodiment, and has the same configuration as the coating removal apparatus 1 other than that. The coating removal apparatus 201 is for stripping off the coating 11 of the coated electric wire 10 illustrated in FIG. 7, for example, as in the first embodiment.

Each contact portion 202 is made of metal and has a cylindrical shape. The contact surface of the contact portion 202 with the coated electric wire 10, that is, the outer circumferential surface of the contact portion 202, is formed with unevenness to increase the frictional force. In this example, the unevenness is formed by knurling. In addition to this, unevenness may be formed on the outer circumferential surface of the contact portion 202 by sandblasting or shotblasting.

The contact portion 202 can prevent deformation of the coating 11 by increasing the contact area with the coating 11, and can strip the coating 11. In addition, since the contact portion 202 has the above-mentioned unevenness formed on the contact surface with the coated electric wire 10, the frictional force on the contact surface can be increased and slippage can be prevented, so that the coating 11 can be more reliably stripped.

The coating removal method of the coating removal apparatus 201 is the same as that of the coating removal apparatus 1 of the first embodiment, so the explanation is omitted.

Like the coating removal apparatus 1 of the first embodiment, the coating removal apparatus 201 described above can effectively remove the coating 11 even when the material of the coating 11 is a soft material or when the removal portion of the coating 11 is long.

Although, in the embodiment described above, an example has been explained in which the moving means moves the contact portion with respect to the fixed coated electric wire, the moving means may move the coated electric wire with respect to the fixed contact portion in the present invention.

In the embodiment described above, an example has been explained in which the coating 11 and the metal foil 12 of the coated electric wire 10, which is a shielded electric wire with a five-layer structure, are removed, but the present invention is not limited thereto. The coating removal apparatus of the present invention can also be applied to, for example, a coated electric wire having a two-layer structure in which a core wire is surrounded by a coating. Also, the number of layers, from the outside of the coated electric wire, to be removed is not particularly limited.

Note that the above-described embodiment merely shows a typical form of the present invention, and the present invention is not limited to this embodiment. That is, various modifications can be made without departing from the gist of the invention. It is to be understood that such modifications are included within the scope of the present invention as long as they still have the structure of the present invention.

### LIST OF REFERENCE SIGNS

1, 101, 201 coating removal apparatus
2, 102, 202 contact portion
3 moving means
10 coated electric wire
11 coating

What is claimed is:

1. A coating removal apparatus comprising:
a plurality of contact portions that are configured to be in surface contact with an outer circumferential surface of a coated electric wire having a circular cross section, the coated electric wire being formed with a notch in a circumferential direction on the outer circumferential surface, the contact portions being configured to sandwich the coated electric wire; and
moving means configured to move the plurality of contact portions sandwiching the coated electric wire and the coated electric wire relative to each other in a longitudinal direction of the coated electric wire,
wherein the plurality of contact portions come into surface contact with an end side of the coated electric wire that is closer to an end of the coated electric wire than the notch, and are moved relatively to the end side in the longitudinal direction of the coated electric wire, so that a coating of the coated electric wire is stripped.

2. The coating removal apparatus according to claim 1, wherein contact surfaces of the contact portions for contact with the coated electric wire are made of rubber.

3. The coating removal apparatus according to claim 1, wherein unevenness is formed on the contact surfaces of the contact portions for contact with the coated electric wire to increase a frictional force.

4. The coating removal apparatus according to claim 1, wherein the contact portions include a plurality of plates arranged at intervals in the longitudinal direction of the coated electric wire, and each of the plurality of plates makes surface contact with the outer circumferential surface of the coated electric wire.
